(19) United States
(12) Patent Application Publication
(10) Pub. No.: US 2007/0079952 A1
(43) Pub. Date: Apr. 12, 2007

(54) Bus heater system

(76) Inventor: Ji-Hyun Mun, Jeonju-si (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/302,077

(22) Filed: Dec. 12, 2005

(30) Foreign Application Priority Data
Oct. 11, 2005 (KR) 10-2005-0095698

(51) Int. Cl. B60H 1/00

(52) U.S. Cl. 165/41; 165/202

(57) ABSTRACT

A bus heater system that includes a plurality of heater units disposed along each side of a floor in a bus in the longitudinal direction of the bus. The bus heater system of the present invention makes it possible for heating levels in several sections in the bus to be independently adjusted. Furthermore, the body of the bus heater system has a markedly reduced volume protruding into the passenger compartment of the bus and reduced operating noise, and can evenly heat the passenger compartment of the bus, thus making the passenger compartment more comfortable.

### CROSS-REFERENCE TO RELATED APPLICATIONS

The present application is based on, and claims priority to Korean Application Serial Number 10-2005-0095698, filed on Oct. 11, 2005, the disclosure of which is incorporated by reference herein in its entirety.

### FIELD OF THE INVENTION

The present invention relates to bus heater system and, more particularly, to a bus heater system which is able to evenly heat a passenger compartment in a bus despite occupying a small space.

### BACKGROUND OF THE INVENTION

Generally, buses have relatively large and long passenger compartments. Thus, it is not easy to evenly heat the passenger compartment of such a bus. If the passenger compartment is not evenly heated, some passengers in the bus may feel hot while other passengers in the same bus may feel cold. Furthermore, in order to make passengers comfortable, a heater should not protrude into the passenger compartment and should not occupy a large space. Additionally, the operating noise would preferable be kept to a minimum level.

### SUMMARY OF THE INVENTION

Embodiments of the present invention provide a bus heater system which has a markedly reduced volume protruding into the passenger compartment of a bus and reduced operating noise, and can evenly heat the passenger compartment of the bus, thus making the passenger compartment more comfortable.

A bus heater system according to one embodiment of the present invention includes a plurality of heater units which are placed along each side of a floor in a bus in a longitudinal direction of the bus. A heater duct surrounds the heater units placed along each side of the floor and includes an air inlet, through which air is drawn into the heater units, and an air outlet, through which air is discharged from the heater units. A blower motor is provided in each of the heater units. A control means classifies the heater units into a front heater unit group placed in a front portion of the bus, a middle heater unit group placed in a middle portion of the bus, and a rear heater unit group placed in a rear portion of the bus and controls rotating speeds of the blower motors provided in the respective groups of heater units.

### BRIEF DESCRIPTION OF THE DRAWINGS

For a better understanding of the nature and objects of the present invention, reference should be made to the following detailed description with the accompanying drawings, in which:

FIG. 1 is a perspective view showing an external structure of a bus heater system, according to a preferred embodiment of the present invention;

FIG. 2 is a perspective view showing the bus heater system of FIG. 1, from which heater ducts have been removed;

FIG. 3 is a perspective view showing a portion of the bus heater system of FIG. 1;

FIG. 4 is a perspective view illustrating a heater unit of the bus heater system according to the present invention;

FIG. 5 is a perspective view showing the heater unit of FIG. 4, from which most of the radiation fins have been removed and to which only several remaining radiation fins are coupled;

FIG. 6 is a sectional view taken along the line VI-VI of FIG. 3; and

FIG. 7 is a diagram showing an electric switch assembly which controls blower motors, according to the present invention.

### DETAILED DESCRIPTION OF THE PREFERRED EMBODIMENTS

Hereinafter, a preferred embodiment of the present invention will be described in detail with reference to the attached drawings.

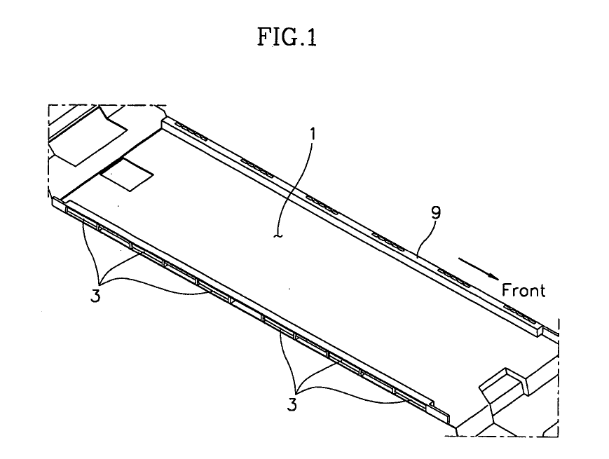

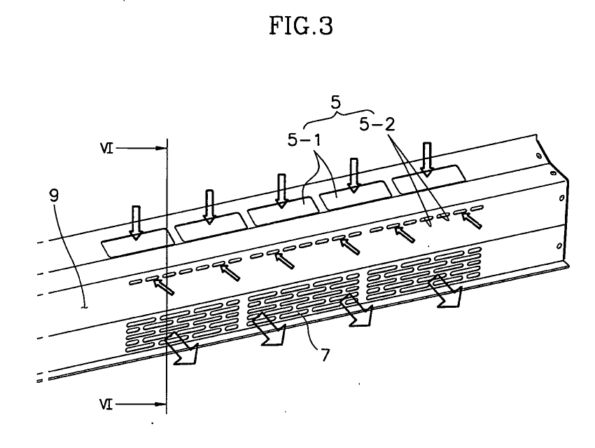

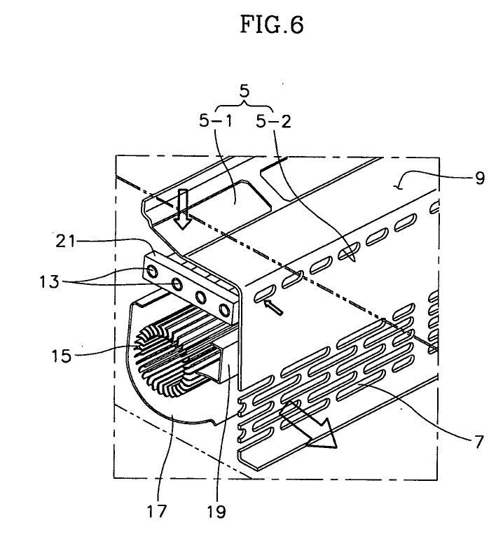

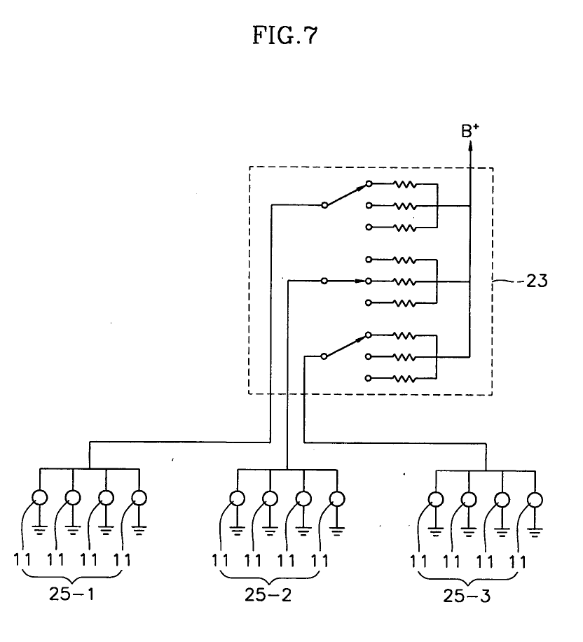

Referring to FIGS. 1 through 7, a bus heater system according to the preferred embodiment of the present invention includes a plurality of heater units 3 which are placed along each side of a floor 1 in a bus in the longitudinal direction of the bus, and a heater duct 9 which surrounds the heater units 3 placed along each side of the floor 1. Each heater duct 9 has an air inlet 5, through which air is drawn into the heater units 3, and an air outlet 7, through which air is discharged from the heater units 3. The bus heater system further includes a blower motor 11 which is provided in each heater unit 3. The heater units 3 are divided into three groups, which consist of a front heater unit group placed in a front portion of the bus, a middle heater unit group placed in a middle portion of the bus, and a rear heater unit group placed in a rear portion of the bus. The bus heater system further includes a control means which separately controls rotating speeds of the blower motors 11 provided in the respective groups of heater units 3.

Each heater unit 3 has a plurality of heat exchange pipes 13, which are formed in a U-shape. The heat exchange pipes 13 are supplied with coolant from an engine and are constructed such that the coolant flows in the longitudinal direction of the bus. Each heater unit 3 further has a cross flow fan 15 which is disposed below the heat exchange pipes 13 and extends a predetermined length in the longitudinal direction of the bus. The cross flow fan 15 is operated by the blower motor 11. Each heater unit 3 further includes an air guide 17 that surrounds both a lower portion of the cross flow fan 15 and an outer portion of the cross flow fan 15 that faces a sidewall of a bus body. Each heater unit 3 also includes a shielding duct 19 that is provided at a predetermined position adjacent to an inner portion of the cross flow fan which faces the inside of the bus body. The shielding duct 19 is vertically spaced apart from the air guide 17 by a predetermined distance.

In this embodiment, two heat exchange pipes 13 are provided in each heater unit 3. The two heat exchange pipes 13 are placed in the same plane and are arranged such that one heat exchange pipe 13 surrounds the other heat exchange pipe 13. A plurality of radiation fins 21 are provided on the heat exchange pipes 13.

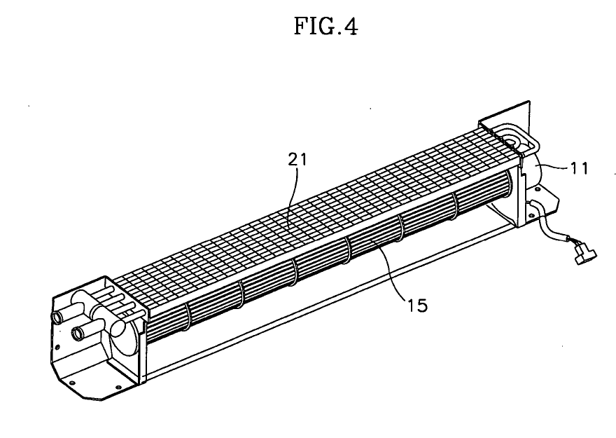

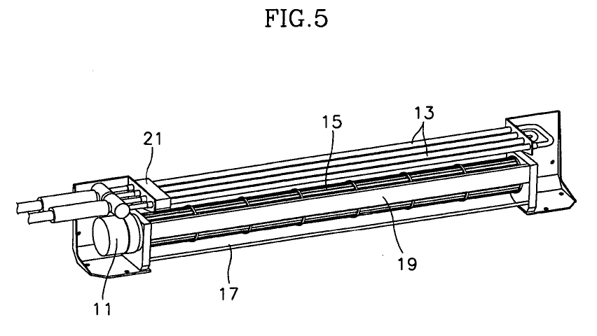

FIG. 4 illustrates the state in which all radiation fins 21 are mounted to the heat exchange pipes 13. FIG. 5 illustrates a state in which most radiation fins 21, other than a few radiation fins 21, may be removed from the heat exchange pipes 13 to show the heat exchange pipes 13.

Each heater duct 9 is formed by a relatively long plate having an approximately L-shaped cross-section. The heater duct 9 surrounds both upper surfaces of the heater units 3 and side surfaces of the heater units 3 which face the inside of the bus body. A plurality of air inlets 5 is formed in the heater duct 9 at a position higher than the shielding duct 19. A plurality of air outlets 7 is formed in the heater duct 9 at a position lower than the shielding duct 19.

The air inlets 5 are divided into two sections, which include main air inlets 5-1, which are formed in the upper surface of the heater duct 9, and subsidiary air inlets 5-2, which are formed in a sidewall of the heater duct 9. The control means includes an electric switch assembly 23, which adjusts the power of a battery between three levels and supplies the power from the battery to the blower motors 11 of the respective front, middle and rear heater unit groups.

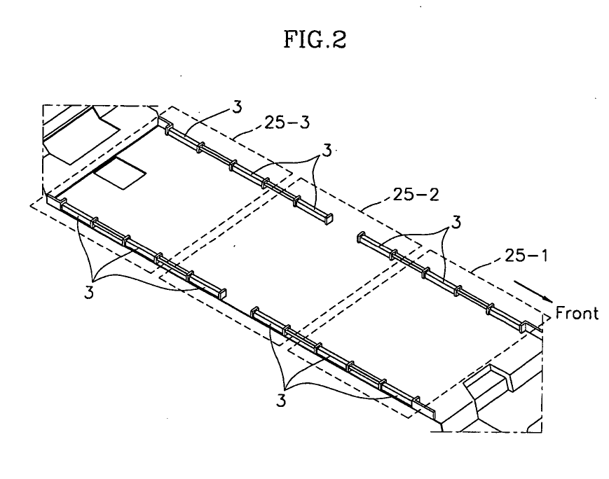

In this embodiment, as shown in FIG. 2, the heater unit groups are divided into three groups including a front heater unit group 25-1, a middle heater unit group 25-2 and a rear heater unit group 25-3, each which has at least four heater units 3. The coolant that has received heat from the engine may be supplied to the heater units 3. The coolant radiates heat while passing through the heat exchange pipes 13 and may be discharged.

The blower motors 11 are operated using power supplied from the electric switch assembly 23. The blower motors 11 may rotate the cross flow fans 15 in three levels, including a high level speed, middle level speed, or low level speed, to blow heat radiated from the heat exchangers 13 into a passenger compartment, based on the manipulation of three switches, provided in the electric switch assembly 23, by a user.

In other words, the blower motors 11 provided in the front heater unit group 25-1, the blower motors 11 provided in the middle heater unit group 25-2, and the blower motors 11 provided in the rear heater unit group 25-3 may be separately rotated at three levels. Thus, heating rates of a front space, a middle space and a rear space in the passenger compartment of the bus can be independently adjusted between three levels. As a result, the interior of the bus may be evenly heated by the manipulation of a user using an electric switch assembly 23.

As described above, the present invention includes the plurality of heater units 3 each having both the blower motor 11 and the cross flow fan 15, and the heater units 3 can simultaneously conduct heating operation. Consequently, despite a low rotating speed of the blower motors 11 and the cross flow fans 15, the interior of the bus may be adequately heated. As a result, embodiments of the present invention may greatly reduce noise produced during the heating process.

As is apparent from the foregoing, the present invention provides a bus heater system which includes a plurality of heater units disposed along each side of a floor in a bus in the longitudinal direction of the bus and makes it possible for heating levels of several sections in the bus to be separately adjusted. Furthermore, embodiments of the present invention provide for configurations of a bus heater with a markedly reduced volume protruding into the passenger compartment of the bus and reduced operating noise, and can evenly heat the passenger compartment of the bus, thus making the passenger compartment more comfortable.

What is claimed is:

1. A bus heater system, comprising:
a plurality of heater units placed along each side of a floor in a bus in a longitudinal direction of the bus;
a heater duct surrounding the heater units placed along each side of the floor and comprising an air inlet, through which air is drawn into the heater units, and an air outlet, through which air is discharged from the heater units;
a blower motor provided in each of the heater units; and
control means wherein the heater units are comprise a front heater unit group placed in a front portion of the bus, a middle heater unit group placed in a middle portion of the bus, and a rear heater unit group placed in a rear portion of the bus and controlling rotating speeds of the blower motors provided in the respective groups of heater units.

2. The bus heater system as defined in claim 1, wherein each heater unit comprises:
a plurality of heat exchange pipes, each having a U-shape, supplied with coolant from an engine and constructed such that the coolant flows in a longitudinal direction of the bus;
a cross flow fan disposed below the heat exchange pipes and extending a predetermined length in the longitudinal direction of the bus, the cross flow fan being operated by the blower motor;
an air guide surrounding both a lower portion of the cross flow fan and an outer portion of the cross flow fan which faces a sidewall of a bus body; and
a shielding duct provided at a predetermined position adjacent to an inner portion of the cross flow fan which faces an inside of the bus body, the shielding duct being vertically spaced apart from the air guide by a predetermined distance.

3. The bus heater system as defined in claim 2, wherein the heater duct comprises a plurality of air inlets provided at a position higher than the shielding duct, and the air outlet of the heater duct comprises a plurality of air outlets provided at a position lower than the shielding duct.

4. The bus heater system as defined in claim 2, wherein the control means adjusts power from a battery between three levels and supplies the power from the battery to the blower motors of the respective front, middle and rear heater unit groups.
